(19) United States
(12) Patent Application Publication
(10) Pub. No.: US 2022/0115738 A1
(43) Pub. Date: Apr. 14, 2022

(54) METHOD OF MANUFACTURING SECONDARY BATTERY SEPARATOR

(71) Applicant: ELECTRONICS AND TELECOMMUNICATIONS RESEARCH INSTITUTE, Daejeon (KR)

(72) Inventors: Ju Young KIM, Sejong (KR); Young-Gi LEE, Daejeon (KR); Seok Hun KANG, Daejeon (KR); YOUNG SAM PARK, Daejeon (KR); Kwang Man KIM, Daejeon (KR)

(21) Appl. No.: 17/393,029

(22) Filed: Aug. 3, 2021

(30) Foreign Application Priority Data
Oct. 13, 2020 (KR) 10-2020-0131715
Dec. 16, 2020 (KR) 10-2020-0176178

(51) Int. Cl. H01M 50/403; H01M 4/62; H01M 50/417; H01M 50/451

(52) U.S. Cl. CPC H01M 50/403; H01M 50/451; H01M 50/417; H01M 4/622

(57) ABSTRACT

Provided is a method of manufacturing a secondary battery separator including dissolving a polymer binder in water to prepare an aqueous binder solution, dispersing particles in the aqueous binder solution to prepare an aqueous slurry, and preparing a separator substrate, and applying the aqueous slurry on an upper surface and a lower surface of the separator substrate to form an aqueous slurry coating layer, wherein the separator substrate includes a hydrophobic material, the polymer binder is water-soluble, and the aqueous slurry has a viscosity of about 100 cP to about 6000 cP.

### CROSS-REFERENCE TO RELATED APPLICATIONS

This U.S. non-provisional patent application claims priority under 35 U.S.C. § 119 of Korean Patent Application Nos. 10-2020-0131715, filed on Oct. 13, 2020, and 10-2020-0176178, filed on Dec. 16, 2020, the entire contents of which are hereby incorporated by reference.

### BACKGROUND

The present disclosure herein relates to a method of manufacturing a secondary battery separator.

Lithium ion secondary batteries currently serve as a core power source for portable electronic communication devices such as mobile phones and notebook computers. The lithium ion secondary batteries provide high storage capacity, excellent charge/discharge characteristics, high processability, etc., which are superior to other energy storage of capacitors and fuel cells, and thus are greatly highlighted as next generation energy storage devices such as a wearable device, an electric vehicle, and an energy storage system (ESS).

Lithium secondary batteries are batteries including a positive electrode, a negative electrode, and an electrolyte and a separator that provide a movement path of lithium ions between the positive electrode and the negative electrode, and produce electric energy through an oxidation-reduction reaction occurring when lithium ions are intercalated/deintercalated into/from the positive electrode and the negative electrode. The voltage and capacity of the lithium secondary batteries are mainly determined depending on materials of the positive electrode and the negative electrode, and an organic solvent in which lithium salts are dissolved is used as an organic liquid electrolyte to facilitate battery operation.

However, the use of a non-aqueous electrolyte having a high risk of ignition and the operation performed at high voltage levels may cause unexpected fires. In particular, the fact that the secondary battery industry trend is shifting from small-sized secondary batteries such as power sources for mobile phones and portable devices to medium- and large-sized secondary batteries for electric vehicles and energy storage systems brings with it growing significance of stability.

### SUMMARY

The present disclosure provides a secondary battery separator having improved thermal stability and mechanical stability, and a method of manufacturing the same.

The present disclosure is not limited to the technical problems described above, and those skilled in the art may understand other technical problems from the following description.

An embodiment of the inventive concept provides a method of manufacturing a secondary battery separator including dissolving a polymer binder in water to prepare an aqueous binder solution, dispersing particles in the aqueous binder solution to prepare an aqueous slurry, and preparing a separator substrate, and applying the aqueous slurry on an upper surface and a lower surface of the separator substrate to form an aqueous slurry coating layer, wherein the separator substrate may include a hydrophobic material, the polymer binder may be water-soluble, and the aqueous slurry may have a viscosity of about 100 cP to about 6000 cP.

In an embodiment, the polymer binder may contain at least one among polyethylene oxide (PEO), polyvinyl pyrrolidone (PVP), polyvinyl alcohol (PVA), polyacrylamides, poly N-(2-hydroxypropyl) methacrylamide (HPMA), polyethyleneimine (PEI), polyacrylic acid (PAA), divinyl ether-maleic anhydride, polyoxazoline, polyphosphates, polyphosphazenes, xanthan gum, pectins, dextran, carrageenan, guar gum, sodium carboxymethyl cellulose, sodium alginate, hyaluronic acid, and albumin.

In an embodiment, the polymer binder may have a molecular weight of about 50,000 g/mol to about 5,000,000 g/mol.

In an embodiment, the weight of the water may be about 40 wt % to about 70 wt % with respect to the total weight of the aqueous slurry.

In an embodiment, the particles may contain at least one among aluminum oxide, silicon dioxide, titanium dioxide, zirconium dioxide, ruthenium oxide, iron oxide, cobalt oxide, nickel oxide, magnesium oxide, copper, silver, iron, nickel, carbon black, carbon nanotubes, graphene, and graphite.

In an embodiment, the particles may have a particle size (D₅₀) of about 100 nm to about 10 μm.

In an embodiment, the aqueous slurry coating layer may have a thickness of about 10 μm to about 50 μm.

In an embodiment, the method may further include applying the aqueous slurry on the upper surface and the lower surface of the separator substrate, and then drying the aqueous slurry coating layer to form a coating layer, and the coating layer may have a thickness of about 0.5 μm to about 10 μm.

In an embodiment, the coating layer may have a porosity of about 20% to about 80%.

In an embodiment, the separator substrate may include a polyolefin-based material.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a cross-sectional view showing a secondary battery according to an embodiment of the inventive concept;

FIG. 2 is a view enlarging and showing region A of FIG. 1; and

FIG. 3 is a flowchart for describing a method of manufacturing a secondary battery separator according to an embodiment of the inventive concept.

### DETAILED DESCRIPTION

In order to fully understand the configuration and effects of the inventive concept, preferred embodiments of the inventive concept will be described below in more detail with reference to the accompanying drawings.

The inventive concept may be embodied in different forms and variously modified and changed, and should not be constructed as limited to the embodiments set forth herein. Rather, these embodiments are provided so that this disclosure will be thorough and complete, and will fully convey the scope of the inventive concept to those skilled in the art. In the drawings, the sizes of respective elements are exaggerated for convenience of description, and the ratios of respective elements may be exaggerated or reduced.

The terminology used herein is not for delimiting the embodiments of the inventive concept but for describing the embodiments. Unless otherwise defined, all terms used herein have the same meaning as commonly understood by one of ordinary skill in the art to which this invention pertains.

The terms of a singular form may include plural forms unless otherwise specified. It will be further understood that the terms “comprises” and/or “comprising”, when used ‘in this description, specify the presence of stated elements, steps, operations, and/or components, but do not preclude the presence or addition of one or more other elements, steps, operations, and/or components.

It will be understood that when a layer is referred to as being “on” another layer, it can be formed directly on an upper surface of another layer, or a third layer may be interposed therebetween.

Though terms like a first, and a second are used to describe various regions and layers in the present description, the regions and the layers are not limited to these terms. These terms are used only to tell one region or layer from another region or layer. Therefore, a portion referred to as a first portion in one embodiment may be referred to as a second portion in another embodiment. An embodiment described and exemplified herein includes a complementary embodiment thereof. Like reference numerals refer to like elements throughout.

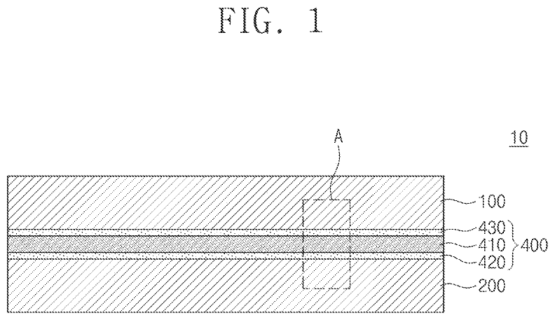

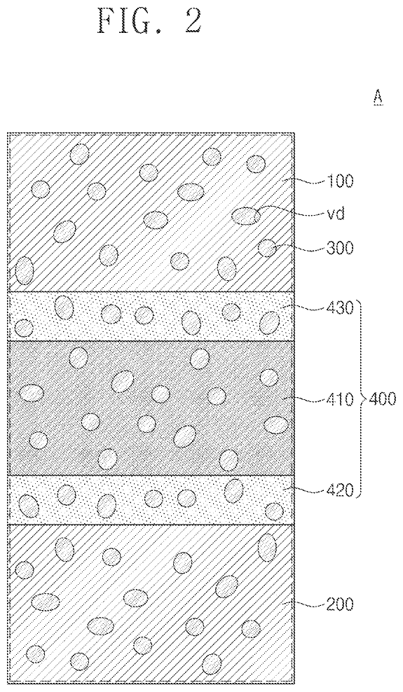

FIG. 1 is a cross-sectional view showing a secondary battery according to an embodiment of the inventive concept. FIG. 2 is a view enlarging and showing region A of FIG. 1.

Referring to FIG. 1, a secondary battery 10 may include a positive electrode 100, a negative electrode 200, an electrolyte 300, and a separator 400. The positive electrode 100 and the negative electrode 200 may be vertically spaced apart from each other, and may face each other. The positive electrode 100, the negative electrode 200, and the separator 400 may include pores vd therein. The electrolyte 300 may be provided inside the pores vd.

The secondary battery 10 may be, for example, a lithium secondary battery. The positive electrode 100 may include a positive electrode active material. The positive electrode active material may include at least one among sulfur, LiCoO₂, LiNiO₂, LiNiₓCo_{y}Mn_{z}O₂ (x+y+z=1), LiMn₂O₄, and LiFePO₄. The negative electrode 200 may include a negative electrode active material. The negative active material may include at least one among silicon (Si), tin (Sn), graphene, graphite, and lithium (Li). The positive electrode 100 and the negative electrode 200 may each include a polymer binder and a conductive material. The polymer binder may include an aqueous polymer, for example, at least one among carboxymethyl cellulose (CMC), polyacrylic acid (PAA)), polyvinylidene fluoride (PVdF), styrene-butadiene rubber (SBR), nitrile rubber (NBR), and polyvinylpyrrolidone (PVP). The conductive material may include at least one of carbon black, carbon nanotube (CNT), or graphene. The conductive material may serve to facilitates movement of electrons. The positive electrode active material, the polymer binder, and the conductive material may be present at a content ratio of about 80:10:10 to about 96:2:2. The negative electrode active material, the polymer binder, and the conductive material may be present at a content ratio of about 80:10:10 to about 96:2:2. However, the embodiment of the inventive concept is not limited thereto, and the polymer binder or the conductive material may be adjusted in content according to characteristics of the positive active material or the negative active material.

The electrolyte 300 may serve to transfer ions to the positive electrode 100 and the negative electrode 200. The electrolyte 300 may include, for example, a liquid electrolyte. The electrolyte 300 may include a lithium salt and an organic solvent. The lithium salt may contain at least one among LiPF₆, LiBF₄, LiSbF₆, LiAsF₆, LiClO₄, LiN(C₂F₅SO₂)₂, LiN(CF₃SO₂)₂, CF₃SO₃Li, LiC(CF₃SO₂)₃, and LiC₄BO₈. The organic solvent may contain cyclic carbonate or linear carbonate. For example, the cyclic carbonate may include at least one among g-butyrolactone, ethylene carbonate, propylene carbonate, glycerin carbonate, vinylene carbonate, and fluoroethylene carbonate. For example, the linear carbonate may include at least one among dimethyl carbonate, diethyl carbonate, ethyl methyl carbonate, dimethoxyethane, and dimethyl ethylene carbonate. The lithium salt in the electrolyte 300 may be present at a concentration of about 1 M to about 5 M. In some embodiments of the inventive concept, the electrolyte 300 may further include an additive to improve secondary battery performance. The additive may include fluoroethylene carbonate or vinylene carbonate.

The separator 400 may be provided between the positive electrode 100 and the negative electrode 200. To be more specific, the separator 400 may be in contact with each of the positive electrode 100 and the negative electrode 200. The separator 400 may prevent electrical shorts between the positive electrode 100 and the negative electrode 200. For example, the separator 400 may include a separator substrate 410, and a lower coating layer 420 and an upper coating layer 430 respectively provided on a lower surface and an upper surface of the separator substrate 410. The separator substrate 410 may include, for example, at least one of polyolefin-based materials such as polyethylene and polypropylene, or cellulose. In some embodiments, the separator substrate may include a porous polymer membrane or a non-woven fabric. The coating layer 430 may be provided on each of the upper surface and the lower surface of the separator substrate 410. For example, the lower coating layer 420 and the upper coating layer 430 on the separator substrate 410 may each have a thickness of about 0.5 μm to about 10 μm. When the lower coating layer 420 and the upper coating layer 430 each have a thickness of less than 0.5 sm, the trouble is, the separator 400 may have reduced thermal stability. When the lower coating layer 420 and the upper coating layer 430 each have a thickness of greater than 10 μm, the trouble is, lithium ions passing through the separator 400 may have reduced permeability, and accordingly, the secondary battery may have increased weight and volume, which may lead to reduction in total volume and energy density per weight. The lower coating layer 420 and the upper coating layer 430 may each have a porosity of about 20% to about 80%.

To be more specific, the lower coating layer 420 and the upper coating layer 430 may be formed by applying an aqueous slurry on the lower surface and the upper surface of the separator substrate 410. The aqueous slurry may include an aqueous binder solution and particles dispersed in the aqueous binder solution. Hereinafter, manufacturing of the separator 400 will be described in detail with reference to FIG. 2.

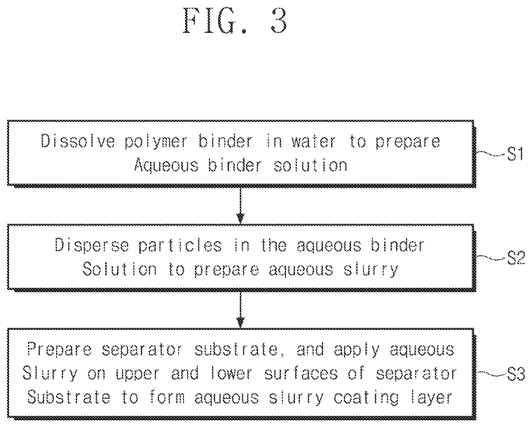

FIG. 3 is a flowchart for describing a method of manufacturing a secondary battery separator according to an embodiment of the inventive concept.

Referring to FIG. 3 together with FIG. 1, a method of manufacturing a separator according to an embodiment of the inventive concept may include dissolving a polymer binder in water to prepare an aqueous binder solution (S1), dispersing particles in the aqueous binder solution to prepare an aqueous slurry (S2), and preparing a separator substrate, and applying the aqueous slurry on an upper surface and a lower surface of the separator substrate to form an aqueous slurry coating layer (S3).

The preparing of the aqueous binder solution (S1) may include dissolving the polymer binder in water. That is, the aqueous binder solution may include water and the polymer binder dissolved in water. The polymer binder may be water-soluble. To be more specific, the polymer binder may have a solubility in water of about 5 wt % or more. For example, the polymer binder may contain at least one among polyethylene oxide (PEO), polyvinyl pyrrolidone (PVP), polyvinyl alcohol (PVA), polyacrylamides, poly N-(2-hydroxypropyl) methacrylamide (HPMA), polyethyleneimine (PEI), polyacrylic acid (PAA), divinyl ether-maleic anhydride, polyoxazoline, polyphosphates, polyphosphazenes, xanthan gum, pectins, dextran, carrageenan, guar gum, sodium carboxymethyl cellulose, sodium alginate, hyaluronic acid, and albumin.

When the polymer binder has a smaller molecular weight, the solubility in water of the polymer binder may increase, and when the polymer binder has a larger molecular weight, the binding force of the polymer binder with the separator substrate 410 may increase. Accordingly, in order to use a polymer binder both having high solubility in water and having high binding force with the separator substrate 410, a polymer binder having an appropriate molecular weight may be required to be used. According to an embodiment of the inventive concept, the polymer binder may have a weight average molecular weight (Mw) of about 50,000 g/mol to about 5,000,000 g/mol. The polymer binder solution may be present at a concentration of about 0.5 wt % to about 20 wt %.

The preparing of the aqueous slurry (S2) may include dispersing particles in the aqueous binder solution. To be more specific, the aqueous slurry may include an aqueous binder solution and particles. For example, the weight of the water may be about 40 wt % to about 70 wt % with respect to the total weight of the aqueous slurry.

The particles may include insulators, semiconductors, conductors, ceramics, and/or metals. For example, the particles may contain at least one among aluminum oxide, silicon dioxide, titanium dioxide, zirconium dioxide, ruthenium oxide, iron oxide, cobalt oxide, nickel oxide, magnesium oxide, copper, silver, iron, nickel, carbon black, carbon nanotubes, graphene, and graphite. The particles may have a particle size (D₅₀) of about 100 nm to about 10 μm. The particle size (D₅₀) of the particles may affect mobility of ions in the lower coating layer 420 and the upper coating layer 430.

For example, the particles and the aqueous binder solution may be present at a composition ratio of about 60:40 to about 99:1, and more preferably about 80:20 to about 99:1, with respect to a weight ratio. For example, the slurry may have a viscosity of about 100 cP to about 6000 cP. When the slurry has a viscosity of less than 100 cP, the slurry mobility is excessively increased due to the low viscosity, which may lead to a deterioration in wettability with the separator substrate 410. When the slurry has a viscosity of greater than 6000 cP, water in the slurry is not sufficient and water volatilizes during the application process, and accordingly, the slurry mobility is excessively reduced, which may lead to failure in uniform application.

The dispersing of the particles in the aqueous binder solution may be performed using a planetary mixer performing rotation and revolution together.

The forming of the aqueous slurry coating layer (S3) may include preparing the separator substrate 410 and applying the aqueous slurry on the surface of the separator substrate 410 to form an aqueous slurry coating layer. To be more specific, the separator substrate 410 may be prepared. The separator substrate 410 may be substantially the same as that described with reference to FIG. 1.

The aqueous slurry coating layer may be formed by applying an aqueous slurry on the upper surface and the lower surface of the separator substrate 410. The applying of the aqueous slurry coating layer may be performed by any one of thickening processes such as a gravure coating method, a small diameter gravure coating method, a reverse roll coating method, a transfer roll coating method, a kiss coating method, a dip coating method, a knife coating method, an air doctor blade coating method, a blade coating method, a bar coating method, a die coating method, a screen printing method, and a spray applying method.

The aqueous slurry is applied on the separator substrate 410, and then the aqueous slurry coating layer may be dried to form the coating layer 430 (see FIG. 1). The drying of the applied aqueous slurry coating layer, for example, may be performed by drying under reduced pressure after hot air drying. However, the embodiment of the inventive concept is not limited thereto, and the drying may be performed using various drying methods capable of completely removing water in the slurry.

Thereafter, the positive electrode 100, the negative electrode 200, and the separator 400 may be assembled to form a cell, and then a liquid electrolyte may be injected into the cell to form the electrolyte 300. An aging process may be performed to allow the injected liquid electrolyte to sufficiently penetrate into the pores vd inside the positive electrode 100, the negative electrode 200, and the separator 400. The aging process may indicate leaving the subject at room temperature for 12 hours or more, and in some cases, the process may indicate leaving the subject at room temperature for more than 6 hours at an elevated temperature (about 40° C. to about 50° C.). Using the aging process, the electrolyte 300 uniformly provided inside the pores vd may be formed.

### Example 1

As a polymer binder, a pectin polymer, which is polysaccharide, was prepared. The pectin polymer was added to water at a ratio of 6 wt %. The water/pectin polymer mixture was stirred on a hot plate at 40° C. to prepare an aqueous binder solution. 9.7 g of aluminum oxide particles were mixed with 5 g of the aqueous binder solution. For uniform mixing, a first stirring was performed for 20 minutes at 2000 rpm using a planetary mixer. For efficient dispersion of the aluminum oxide particles, 10 zirconia balls were added into the planetary mixer and stirred together. The aluminum oxide particles were evenly dispersed through the first stirring process, thereby preparing an aqueous slurry. Water was again added thereto to adjust the viscosity of the aqueous slurry, and then a second stirring was performed for 3 minutes at 2000 rpm using the planetary mixer. After the stirring, the viscosity of the aqueous slurry was 243 cP, and the ratio of the weight of water to the total weight of the aqueous slurry was 57.8 wt %. The aqueous slurry was applied on a separator substrate through a doctor blade method. The application was performed by adjusting the height of the doctor blade so as to finally form a coating layer having a thickness of 5 μm.

### Example 2

A separator was formed in the same manner as in Example 1, except for adding an amount of water less than the amount of water added after the first stirring process in Example 1. In this case, the viscosity of the aqueous slurry was 366 cP, and the ratio of the weight of water to the total weight of the aqueous slurry was 51.7 wt %.

### Example 3

A separator was formed in the same manner as in Example 2, except for adding an amount of water less than the amount of water added after the first stirring process in Example 2. In this case, the viscosity of the aqueous slurry was 3160 cP, and the ratio of the weight of water to the total weight of the aqueous slurry was 49.2 wt %.

### Comparative Example 1

A separator was formed in the same manner as in Example 1, except for adding an amount of water greater than the amount of water added after the first stirring process in Example 1. In this case, the viscosity of the aqueous slurry was 63 cP, and the ratio of the weight of water to the total weight of the aqueous slurry was 62.5 wt %.

### Comparative Example 2

A separator was formed in the same manner as in Example 3, except for adding an amount of water less than the amount of water added after the first stirring process in Example 3. In this case, the viscosity of the aqueous slurry was 9546 cP, and the ratio of the weight of water to the total weight of the aqueous slurry was 43.5 wt %.

### Experimental Example

Table 1 shows characteristics of the separators prepared according to Experimental Examples 1 to 3, and Comparative Examples 1 and 2.

TABLE 1

| | Aluminum | Pectin | Water | Viscosity | Area ratio (%) where a coating layer |
|---|---|---|---|---|---|
| Type | oxide (wt %) | (wt %) | (wt %) | (cP) | is applied on a separator substrate |
| Comparative | 36.6 | 1.1 | 62.5 | 63 | 50.3 |
| Example 1 | | | | | |
| Example 1 | 40.9 | 1.3 | 57.8 | 243 | 94.8 |
| Example 2 | 46.9 | 1.4 | 51.7 | 366 | 98.5 |
| Example 3 | 49.2 | 1.5 | 49.2 | 3160 | 96.7 |
| Comparative | 54.8 | 1.7 | 43.5 | 9546 | 57.9 |
| Example 2 | | | | | |

Referring to Table 1, it is confirmed that according to embodiments of the inventive concept (Examples 1 to 3), wettability between the separator substrate and the coating layer was improved, and accordingly, the coating layer covered the surface of the separator substrate by 95% or greater, whereas Comparative Examples 1 and 2 exhibited a low applied area ratio of about 50%.

In general, for a secondary battery separator, a hydrophobic material is used, and thus, when a hydrophilic coating layer is formed using an aqueous slurry, due to poor wetting properties, a separator may hardly be formed. According to embodiments of the inventive concept, the aqueous slurry has a predetermined viscosity suitable to be optimally applied on the hydrophobic separator substrate, and accordingly, a secondary battery separator in which the coating layer is uniformly formed may be manufactured.

A method of manufacturing a secondary battery separator according to embodiments of the inventive concept may include applying an aqueous slurry on a hydrophobic separator substrate to form a coating layer. The aqueous slurry has a predetermined viscosity value and may be stably applied on a surface of the hydrophobic separator. Accordingly, a method of manufacturing a secondary battery separator having improved operation reliability and stability may be provided.

Effects of the present disclosure are not limited to the effects described above, and those skilled in the art may understand other effects from the following description.

Although the embodiments of the inventive concept have been described above with reference to the accompanying drawings, those skilled in the art to which the inventive concept pertains may implement the inventive concept in other specific forms without changing the technical idea or essential features thereof. Therefore, it should be understood that the embodiments described above are exemplary in all respects and not restrictive.

What is claimed is:

1. A method of manufacturing a secondary battery separator, the method comprising:
dissolving a polymer binder in water to prepare an aqueous binder solution;
dispersing particles in the aqueous binder solution to prepare an aqueous slurry; and
preparing a separator substrate, and applying the aqueous slurry on an upper surface and a lower surface of the separator substrate to form an aqueous slurry coating layer,
wherein the separator substrate includes a hydrophobic material,
the polymer binder is water-soluble, and
the aqueous slurry has a viscosity of about 100 cP to about 6000 cP.

2. The method of claim 1, wherein the polymer binder contains at least one among polyethylene oxide (PEO), polyvinyl pyrrolidone (PVP), polyvinyl alcohol (PVA), polyacrylamides, poly N-(2-hydroxypropyl) methacrylamide (HPMA), polyethyleneimine (PEI), polyacrylic acid (PAA), divinyl ether-maleic anhydride, polyoxazoline, polyphosphates, polyphosphazenes, xanthan gum, pectins, dextran, carrageenan, guar gum, sodium carboxymethyl cellulose, sodium alginate, hyaluronic acid, and albumin.

3. The method of claim 1, wherein the polymer binder has a molecular weight of about 50,000 g/mol to about 5,000,000 g/mol.

4. The method of claim 1, wherein the weight of the water is about 40 wt % to about 70 wt % with respect to the total weight of the aqueous slurry.

5. The method of claim 1, wherein the particles contain at least one among aluminum oxide, silicon dioxide, titanium dioxide, zirconium dioxide, ruthenium oxide, iron oxide, cobalt oxide, nickel oxide, magnesium oxide, copper, silver, iron, nickel, carbon black, carbon nanotubes, graphene, and graphite.

6. The method of claim 5, wherein the particles have a particle size (D₅₀) of about 100 nm to about 10 μm.

7. The method of claim 1, wherein the aqueous slurry coating layer has a thickness of about 10 μm to about 50 μm.

8. The method of claim 1, further comprising applying the aqueous slurry on the upper surface and the lower surface of the separator substrate, and then drying the aqueous slurry coating layer to form a coating layer,
wherein the coating layer has a thickness of about 0.5 μm to about 10 μm.

9. The method of claim 8, wherein the coating layer has a porosity of about 20% to about 80%.

10. The method of claim 1, wherein the separator substrate comprises a polyolefin-based material.
